(19) United States
(12) Patent Application Publication
(10) Pub. No.: US 2014/0308456 A1
(43) Pub. Date: Oct. 16, 2014

(54) APPARATUS AND METHOD FOR CONTROLLED DEPOSITION OF AEROSOLIZED PARTICLES ONTO A SUBSTRATE

(71) Applicant: KLA-Tencor Corporation, Milpitas, CA (US)

(72) Inventors: Yu Guan, Pleasanton, CA (US); Francisco Kole, San Jose, CA (US)

(21) Appl. No.: 14/247,197

(22) Filed: Apr. 7, 2014

Related U.S. Application Data
(60) Provisional application No. 61/810,632, filed on Apr. 10, 2013.

(51) Int. Cl. B05D 1/06; B03C 7/02; B05B 5/00

(52) U.S. Cl. CPC B05D 1/06; B05B 5/00; B03C 7/02
USPC 427/475; 118/624; 209/129

(57) ABSTRACT

An apparatus for the controlled deposition of particles onto a film or a substrate, including: a frame arranged to support a film or a substrate having first and second surfaces facing in first and second opposite directions, respectively; a nozzle arranged to emit a stream of particles charged with a first polarity toward the first surface; and an electrode: charged with a second polarity, opposite the first polarity, and located adjacent the second surface; and arranged to attract the stream of particles to a region of the first surface. A line orthogonal to the first surface passes through the region and the electrode.

### CROSS-REFERENCE TO RELATED APPLICATIONS

This application claims the benefit under 35 U.S.C. §119(e) of U.S. Provisional Patent Application No. 61/810,632, filed Apr. 10, 2013, which application is incorporated herein by reference in its entirety.

### TECHNICAL FIELD

The present disclosure relates to an apparatus and method for controlling the deposition of particles on a substrate and increasing the density of the particles on the substrate to allow for measurement of the size of the deposited particles with transmission electron microscopy.

### BACKGROUND

In order to accurately calibrate the inspection and metrology equipment used in the integrated circuit industry, such as scanning surface inspection systems (SSIS), precise knowledge of the size of the particles used to calibrate such equipment is needed. One way of precisely measuring particles is to deposit an aerosol of uniformly sized, or mono-dispersed, particles on a film or a substrate and measure the size of the particles using transmission electron microscopy (TEM). Once the size of the deposited particles is known, the film or the substrate with the deposited particles can be used to calibrate inspection and metrology equipment.

However, in order to measure particle sizes using TEM, there must be sufficient particle density on the film or substrate. At particle densities lower than the required threshold, it is too difficult to find and measure a particle. Current systems use a charged nozzle and large, planar, oppositely charged electrode beneath the receiving film or substrate to direct the flow of uniformly sized particles from the nozzle to the film or substrate, but are only capable of achieving particle densities of approximately 10⁵/mm², which is far below the approximately 10⁸/mm² particle density required for measurement via TEM.

Currently, the only way to achieve the particle densities required by TEM is to apply unfiltered, non-uniformly sized particles in the form of a colloidal liquid onto the film or substrate. However, the range of sizes of such unfiltered particles is very large using this deposition method, typically 30-50% in full width at half maximum, which is 3-10 times larger than the variance in the sizes of the particles in the uniformly sized particle aerosol described above. Due to this variance, the actual sizes of the particles used for the calibration are unknown, as they may be of a different size than the particles measured via TEM.

### SUMMARY

According to aspects illustrated herein, there is provided an apparatus for the controlled deposition of particles onto a film or a substrate, including: a frame arranged to support a film or a substrate having first and second surfaces facing in first and second opposite directions, respectively; a nozzle arranged to emit a stream of particles charged with a first polarity toward the first surface; and an electrode: charged with a second polarity, opposite the first polarity, and located adjacent the second surface; and arranged to attract the stream of particles to a region of the first surface. A line orthogonal to the first surface passes through the region and the electrode.

According to aspects illustrated herein, there is provided an apparatus for the controlled separation of particles, including: a frame with an aperture; a nozzle arranged to emit a stream of particles comprising particles charged with a first polarity and having a non-uniform quality toward the frame; a collecting vessel; and an electrode charged with a second polarity, opposite the first polarity, and located adjacent the second surface and arranged to attract the stream of particles toward the aperture in the frame, separate first particles having a predetermined quality from the stream of particles and direct the first particles through the aperture in the frame and into the collecting vessel.

According to aspects illustrated herein, there is provided a method for controlled deposition of particles onto a film or a substrate, including: disposing a nozzle to face a first surface of a film or a substrate, the first surface facing in a first direction; disposing an electrode proximate a second surface facing in a second direction, opposite the first direction, of the film or the substrate; charging the electrode with a first polarity; streaming, from the nozzle, a plurality of particles, charged with a second polarity, opposite the first polarity; attracting the plurality of particles to a region of the first surface; and depositing the plurality of particles on the region of the first surface.

According to aspects illustrated herein, there is provided method for controlled separation of particles, including: emitting, using the nozzle, a stream of particles charged with the first polarity and having a non-uniform quality towards a frame; positioning an electrode adjacent an aperture in the frame; charging the electrode with a second polarity opposite the first polarity; attracting, with the electrode, the stream of particles toward the aperture in the frame; separating, with the electrode, first particles having a predetermined quality from the stream of particles; and directing, with the electrode, the first particles through the aperture in the frame and into the collecting vessel.

### BRIEF DESCRIPTION OF THE DRAWINGS

Various embodiments are disclosed, by way of example only, with reference to the accompanying schematic drawing in which:

FIG. 1A depicts a schematic representation of a detail of an apparatus for controlled deposition of aerosolized particles onto a substrate using an electric field;

FIG. 1B depicts a schematic representation of a detail of an apparatus for controlled deposition of aerosolized particles onto a substrate using an electrostatic field;

FIG. 2 is a schematic representation of an apparatus for controlled deposition of aerosolized particles onto a film or a substrate with a plurality of focusing electrodes, an actuator, and a flow control mechanism; and,

FIG. 3 is a schematic representation of an apparatus for controlled separation of aerosolized particles.

### DETAILED DESCRIPTION

At the outset, it should be appreciated that like drawing numbers on different drawing views identify identical, or functionally similar, structural elements of the embodiments set forth herein. Additionally, it should be understood that the disclosure as claimed is not limited to the disclosed aspects.

Furthermore, it is understood that this patent is not limited to the particular methodology, materials and modifications described and as such may, of course, vary. It is also understood that the terminology used herein is for the purpose of describing particular aspects only, and is not intended to limit the scope of the present disclosure.

Unless defined otherwise, all technical and scientific terms used herein have the same meaning as commonly understood to one of ordinary skill in the art to which this disclosure belongs. It should be understood that any methods, devices or materials similar or equivalent to those described herein can be used in the practice or testing of the disclosure.

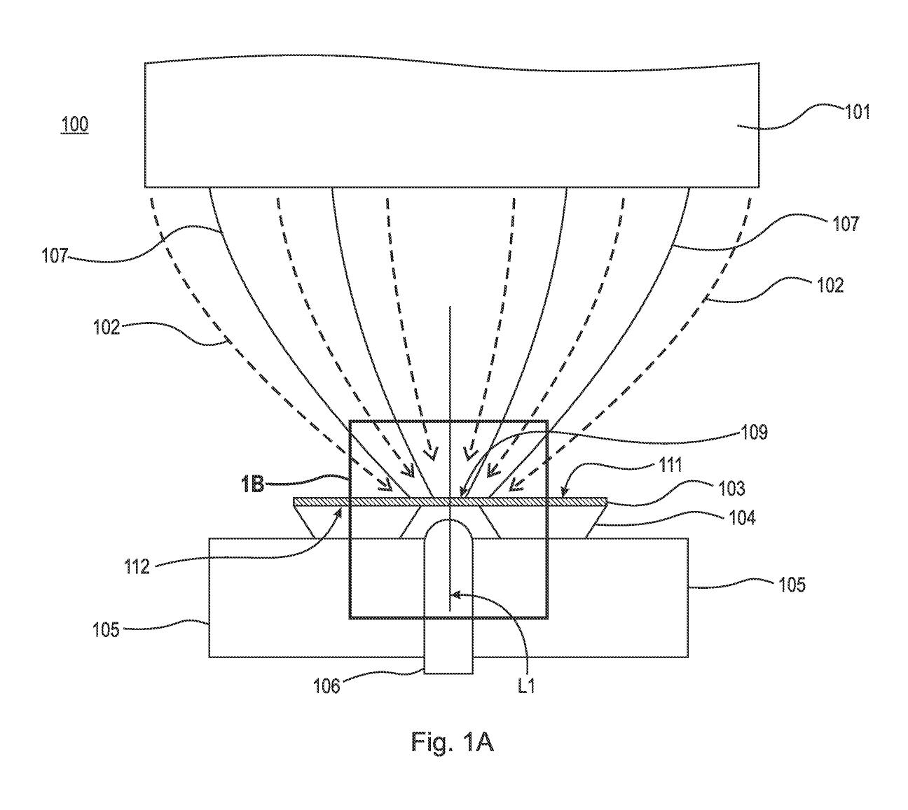

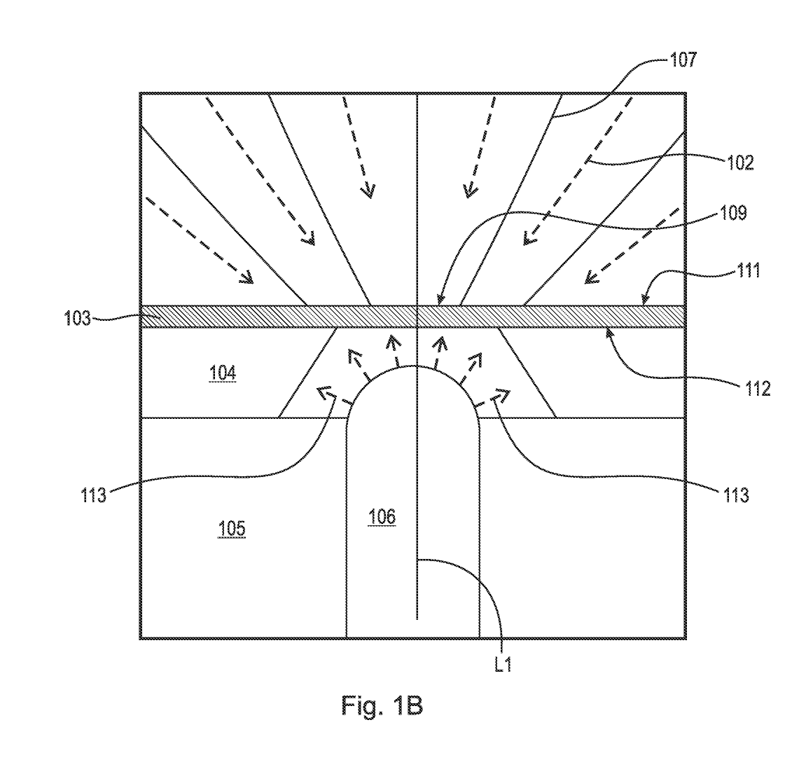

FIG. 1A depicts a schematic representation of apparatus 100 for controlled deposition of aerosolized particles onto a substrate using an electric field. Apparatus 100 includes nozzle 101 arranged to emit a stream of particles 102 towards film or substrate 103. The particles are charged with a first polarity before being emitted by the nozzle. In an example embodiment, the particles in stream of particles 102 are of a substantially uniform size. Apparatus 100 also includes electrode 106 charged with a second polarity, opposite the first polarity. Film or substrate 103 has a first surface 111 and a second surface 112. Surfaces 111 and 112 face in opposite directions from each other, i.e., the surfaces are on opposite sides of film or substrate 103 from each other. First surface 111 of film or substrate 103 is on the side of film or substrate 103 facing nozzle 101. Film or substrate 103 is supported by frame 104. In an example embodiment, frame 104 is supported by insulator 105. Electrode 106 is adjacent to second surface 112, i.e., electrode 106 is on the opposite side of film or substrate 103 from nozzle 101.

As further described below, electrode 106 is arranged to attract the stream of particles to region 109 of surface 111. As further described below, electrode 106 helps define a location, shape, and size of region 111, for example, line L1 orthogonal to the surface 111 passes through region 109 and the electrode. In an example embodiment, nozzle 101 has a diameter in the range of 1 mm to 5 mm and is between a few mm to tens of cm away from film or substrate 103. Although stream of particles 102 is depicted by dashed arrows in FIG. 1, it is not limited to the discrete paths represented by these dashed arrows and is understood to be a continuous flow from the full diameter of nozzle 101.

FIG. 1B depicts a schematic representation of a detail of apparatus 100 for controlled deposition of aerosolized particles onto a substrate using an electrostatic field. In an example embodiment, nozzle 101 is electrically grounded and the charge on electrode 106 creates electrostatic field 113 that attracts the stream of particles to region 109. In an example embodiment, nozzle 101 is charged with the same polarity as the particles, and the nozzle and the electrode create electric field 107 that attracts the stream of particles to region 109. The discussion that follows is directed to field 107; however, it should be understood that the discussion is applicable to field 113 unless stated otherwise.

In an example embodiment, electrode 106 is formed so that the profile of the electrode facing second surface 112 is the shape of a circle, ellipse, a square, a rectangle, a polygon, and/or a combination of straight and curved lines, including complex composite shapes. In an example embodiment, electric field 107 is in the range of 0 kV to 30 kV. In an example embodiment, nozzle 101 is tapered and the end of electrode 106 adjacent to second surface 112 is substantially rounded, i.e., substantially hemispherical, in order to reduce the gradient of the strength of electric field 107 and, thus, the risk of electrical arcing between nozzle 101 and electrode 106.

As the profile of electrode 106 which is adjacent to second surface 112 is relatively small compared to the width of nozzle 101, electric field 107 tends to deflect the individual particles in stream of particles 102 from their respective initial courses from nozzle 101 to the region of first surface 111 wherein a line orthogonal to first surface 111 passes through the region and electrode 106, thereby increasing the density of particles deposited within this region on film or substrate 103. In an example embodiment, this region of particle deposition on first surface 111 is between 0.1 mm and 1 mm in diameter, which diameter is generally equivalent to the diameter of the profile of electrode 106. In an example embodiment, the area of the region of particle deposition on first surface 111 is generally smaller than the area of nozzle 101 which is coplanar to first surface 111. This concentrating effect allows for particle densities on the targeted region of the film or substrate of approximately 10⁸/mm², which is sufficient to measure the size of the deposited particles using TEM.

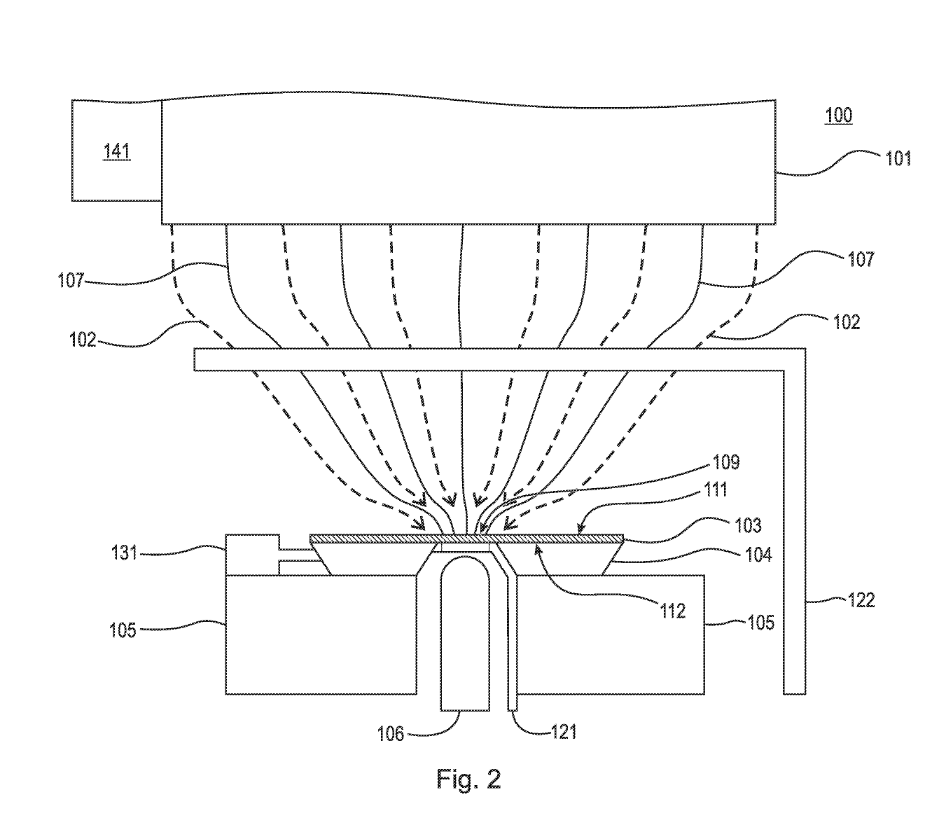

FIG. 2 depicts a schematic representation of an apparatus for controlled deposition of aerosolized particles onto a film or a substrate with a plurality of focusing electrodes, an actuator, and a flow control mechanism. Focusing electrodes 121 and 122 have a polarity equivalent to the polarity of nozzle 101. As the charge of the particles in stream of particles 102 have equivalent polarity to nozzle 101, stream of particles 102 is repelled by the similarly charged focusing electrodes 121 and 122. This additional effect on the direction of stream of particles 102 provides additional control over region 109, the size and shape of the region, and the density of the deposition of particles on film or substrate 103. Although two focusing electrodes are shown in FIG. 2, it should be understood that a single focusing electrode can be used in apparatus 100.

In an example embodiment, one or more focusing electrodes are used to “defocus” stream of particles 102 by increasing the region of deposition on film or substrate 103, either through the position of the focusing electrodes or by charging the focusing electrodes with a polarity equivalent to the polarity of electrode 106. Focusing electrode 121 is in the form of a ring coaxial to electrode 106 and adjacent to second surface 112. Focusing electrode 122 is in the form of a disk with an aperture, through which aperture electric field 107 passes and stream of particles 102 is directed. In an example embodiment, focusing electrodes 121 and 122 take the form of cylinders with through-bores, tubes, or plates, with or without apertures. In an example embodiment, focusing electrodes 121 and 122 may generate a magnetic field in order to direct the direction of stream of particles 102. Any number, combination, configuration, and location of the types and shapes of focusing electrodes described above are possible.

At least one actuator 131 is connected to frame 104 and arranged to translate frame 104 and film or substrate 103 relative to the path of stream of particles 102. In an example embodiment, multiple actuators are used to provide translation in multiple directions. This translation changes the region of first surface 111 onto which particles are deposited. By translating frame 104 and film or substrate 103, it is possible to create patterns of particle deposition on film or substrate 103. These patterns may be arrays of simple points, lines, or complex shapes.

Flow control mechanism 141 is arranged to adjust the rate of flow of stream of particles 102 from nozzle 101. By adjusting the rate of flow of stream of particles 102, it is possible to finely control the density of particles deposited on film or substrate 103. Furthermore, in combination with the translation of film or substrate 103 by actuator 131, it is possible to create patterns of particle deposition on film or substrate 103 that vary in particle density, such that particle density varies as a function of location on film or substrate 103. These complex patterns can then be used to test the sensitivity of the inspection and metrology equipment being calibrated with film or substrate 103.

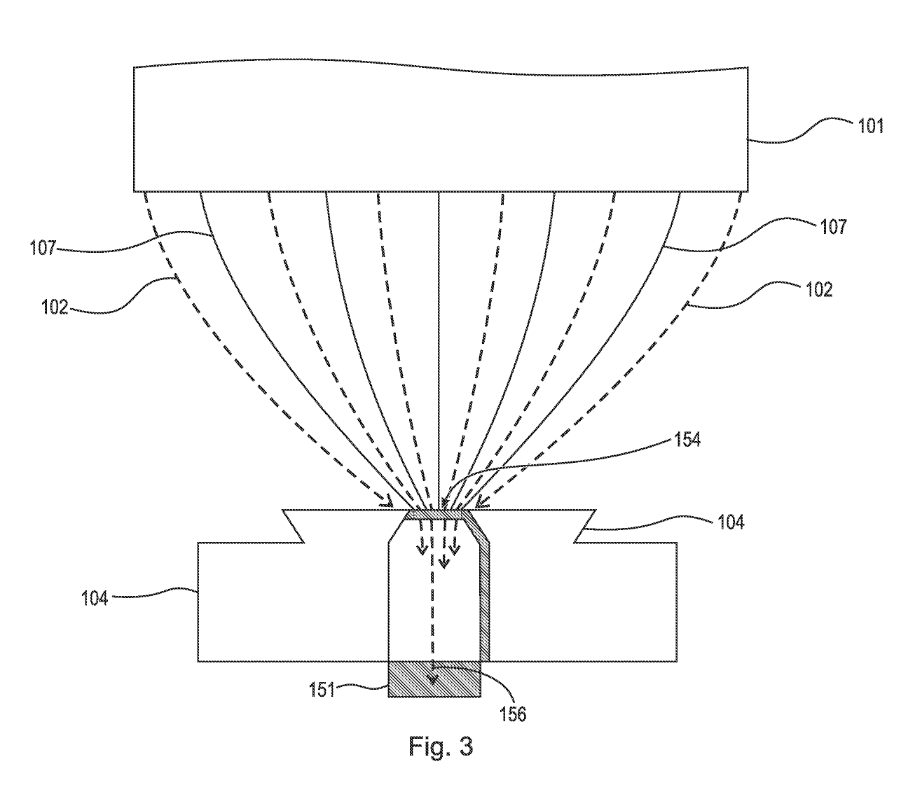

FIG. 3 depicts a schematic representation of an apparatus for controlled separation of aerosolized particles. Nozzle 101 is arranged to emit particles 102 towards frame 104. Particles 102 are pre-charged at a first polarity and have a non-uniform quality. Electrode 152 is arranged adjacent an aperture in frame 104 that opens into a channel leading to collection vessel 151. Electrode 152 is charged with a polarity that is opposite the polarity of particles 102. Electrode 152 is arranged to attract particles 102 toward aperture 154 in the frame, separate particles 156 having a predetermined quality from particles 102, and direct particles 156 through the aperture and into the collecting vessel.

In an example embodiment, nozzle 101 is electrically grounded and the charge on electrode 152 creates an electrostatic field (not shown to preserve the clarity of FIG. 3, but similar to field 113 in FIG. 1B) that attracts particles 102 toward aperture 154 in the frame, separates particles 156 having a predetermined quality from particles 102, and directs particles 156 through the aperture and into the collecting vessel. In an example embodiment, nozzle 101 is charged with the same polarity as the particles, and the nozzle and the electrode create electric field 107 that attracts particles 102 toward aperture 154 in the frame, separates particles 156 having a predetermined quality from particles 102, and directs particles 156 through the aperture and into the collecting vessel.

Electric field 107 and the electrostatic field are arranged to generally direct stream of particles 102 to the aperture in frame 104. The strength of electric field 107 or the electrostatic field determines how strongly electric field 107 and the electrostatic field are able to deflect the individual particles in stream of particles 102 from their respective initial course from nozzle 101 to the aperture in frame 104. Furthermore, certain qualities of the particles in stream of particles 102, such as mass, electric charge, and size, affect how strongly electric field 107 or the electrostatic field are able to deflect the individual particles in stream of particles 102. Therefore, by varying the strength of electric field 107 or the electrostatic field are, it is possible to ensure that only particles 156 possessing one or more predetermined qualities, such as a specific size, are deflected enough to enter the aperture in frame 104 adjacent electrode 152 and travel through the channel in frame 104 to collection vessel 151. In an example embodiment, collection vessel 151 contains a liquid to capture particles 156 possessing the predetermined quality or qualities. These captured particles can then be gathered from the liquid via physical or chemical enrichment processes, such as evaporation or dielectrophoresis.

It will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

What is claimed is:

1. An apparatus for the controlled deposition of particles onto a film or a substrate, comprising:
a frame arranged to support a film or a substrate having first and second surfaces facing in first and second opposite directions, respectively;
a nozzle arranged to emit a stream of particles charged with a first polarity toward the first surface; and,
an electrode:
charged with a second polarity, opposite the first polarity, and located adjacent the second surface; and,
arranged to attract the stream of particles to a region of the first surface, wherein:
a line orthogonal to the first surface passes through the region and the electrode.

2. The apparatus recited in claim 1, wherein:
the nozzle is electrically grounded; and,
the electrode is arranged to create an electrostatic field that attracts the stream of particles to the region of the first surface.

3. The apparatus recited in claim 1, wherein:
the nozzle is charged with the first polarity; and,
the nozzle and the electrode is arranged to create an electric field that attracts the stream of particles to the region of the first surface.

4. The apparatus recited in claim 1, wherein particles in the stream of particles are of a substantially uniform size.

5. The apparatus recited in claim 1, wherein an end of the electrode closest to the second surface of the film or the substrate is substantially rounded.

6. The apparatus recited in claim 1, wherein a cross-section of the electrode coplanar with the first surface has a shape selected from the group consisting of a circle, an ellipse, a square, a rectangle, a polygon, and a combination of straight and curved lines.

7. The apparatus recited in claim 1, wherein an area of the region of the first surface is smaller than an area of the nozzle co-planar with the first surface.

8. The apparatus recited in claim 1, further comprising:
at least one focusing electrode located:
between the nozzle and the first surface of the film or the substrate; or,
adjacent the second surface of the film or the substrate.

9. The apparatus recited in claim 8, wherein the at least one focusing electrode is arranged to direct the stream of particles toward the region of the first surface.

10. The apparatus recited in claim 8, wherein at least one of the focusing electrode is arranged between the nozzle and the film or the substrate.

11. The apparatus recited in claim 8, wherein at least one of the focusing electrode is arranged adjacent the second surface.

12. The apparatus recited in claim 8, wherein:
the at least one focusing electrode comprises a disk or a plate with a respective aperture; and,
the stream of particles is arranged to pass through the respective aperture.

13. The apparatus recited in claim 8, wherein at least one of the focusing electrode includes a plurality of focusing electrodes.

14. The apparatus recited in claim 8, wherein at least one of the focusing electrode includes a single focusing electrode enclosing an aperture.

15. The apparatus recited in claim 8, wherein the at least one focusing electrode includes:
a first focusing electrode located between the nozzle and the first surface of the film or the substrate; and,
a second focusing electrode located adjacent the second surface of the film or the substrate.

16. The apparatus recited in claim 1, further comprising:
an actuator connected to the frame and arranged to translate the film or the substrate relative to the stream of particles.

17. The apparatus recited in claim 1, further comprising:
a flow control mechanism arranged to adjust a rate of flow of the stream of particles from the nozzle.

18. An apparatus for the controlled separation of particles, comprising:
an aperture in a frame;
a nozzle arranged to emit a stream of particles comprising particles charged with a first polarity and having a non-uniform quality toward the frame;
a collecting vessel; and;
an electrode:
charged with a second polarity, opposite the first polarity, and located adjacent the second surface; and,
arranged to:
attract the stream of particles toward the aperture in the frame;
separate first particles having a predetermined quality from the stream of particles; and,
direct the first particles through the aperture in the frame and into the collecting vessel.

19. The apparatus recited in claim 18, wherein:
the nozzle is electrically grounded; and,
the electrode is arranged to create an electrostatic field that:
attracts the stream of particles toward the aperture;
separates the first particles from the stream of particles; and,
directs the first particles through the aperture and into the collecting vessel.

20. The apparatus recited in claim 18, wherein:
the nozzle is charged with the first polarity; and,
the nozzle and the electrode is arranged to create an electric field that:
attracts the stream of particles toward the aperture;
separates the first particles from the stream of particles; and,
directs the first particles through the aperture and into the collecting vessel.

21. The apparatus recited in claim 18, wherein the predetermined quality is a size of the particles.

22. A method for controlled deposition of particles onto a film or a substrate, comprising:
disposing a nozzle to face a first surface of a film or a substrate, the first surface facing in a first direction;
disposing an electrode proximate a second surface facing in a second direction, opposite the first direction, of the film or the substrate;
charging the electrode with a first polarity;
streaming, from the nozzle, a plurality of particles, charged with a second polarity, opposite the first polarity;
attracting the plurality of particles to a region of the first surface; and,
depositing the plurality of particles on the region of the first surface.

23. The method recited in claim 22, further comprising:
electrically grounding the nozzle; and,
creating, with the electrode, an electrostatic field, wherein attracting the plurality of particles to the region of the first surface includes attracting the stream of particles with the electrostatic field.

24. The method recited in claim 23, further comprising:
altering a respective characteristic the electrostatic field or the region using at least one focusing electrode.

25. The apparatus recited in claim 22, wherein:
charging the nozzle with the second polarity; and,
creating, with the nozzle and the electrode, an electric field, wherein attracting the plurality of particles to the region of the first surface includes attracting the stream of particles with the electric field.

26. The method recited in claim 25, further comprising:
altering a respective characteristic the electric field or the region using at least one focusing electrode.

27. The method recited in claim 22, wherein streaming the plurality of particles includes streaming particles with a substantially uniform size.

28. The method recited in claim 22, further comprising:
forming the region to have an outline selected from the group consisting of a circle, an ellipse, a square, a rectangle, a polygon, and a combination of straight and curved lines.

29. The method recited in claim 22, wherein an area of the region of the first surface is smaller than an area of the nozzle co-planar with the first surface.

30. The method recited in claim 22, further comprising:
altering a size or shape of the region using at least one focusing electrode.

31. The method recited in claim 30, wherein altering a size or shape of the region includes using a single focusing electrode or a plurality of focusing electrodes.

32. The method recited in claim 30, further comprising:
creating, using the electrode, an electrostatic field or an electric field; and,
positioning the at least one focusing electrode between the nozzle and the film or the substrate, wherein altering the size or shape of the region includes:
focusing the electrostatic field or defocusing the electrostatic field; or,
focusing the electric field or defocusing the electric field.

33. The method recited in claim 30, wherein:
the at least one focusing electrode includes a single focusing electrode enclosing an aperture; and,
altering the size or shape of the region includes passing the electrostatic field or the electric field through the aperture.

34. The method recited in claim 30, wherein:
the at least one focusing electrode includes a disc or plate with a respective aperture; and,
altering the size or shape of the region includes passing the electrostatic field or the electric field through the respective aperture.

35. The method recited in claim 30, further comprising:
positioning the at least one focusing electrode adjacent the second surface.

36. The method recited in claim 30, wherein the at least one focusing electrode includes:
a single focusing electrode surrounding the electrode; or,
a plurality of focusing electrodes disposes about the electrode in directions orthogonal to the second direction.

37. The method recited in claim 30, further comprising:
creating, using the electrode, an electrostatic field or an electric field;
positioning a first focusing electrode between the nozzle and the first surface of the film or the substrate;
altering the shape of the electrostatic field or the electric field with the first focusing electrode;
positioning a second focusing electrode adjacent the second surface; and,
altering the size or shape of the region with the second focusing electrode.

38. The method recited in claim 22, further comprising:
positioning the film or the substrate on a frame; and,
displacing the frame with an actuator to control a portion of the film or the substrate intercepted by the electric field.

39. The method recited in claim 22, further comprising:
adjusting a rate of flow of the stream of particles from the nozzle with a flow control mechanism.

40. A method for controlled separation of particles, comprising:
emitting, using the nozzle, a stream of particles charged with the first polarity and having a non-uniform quality towards a frame;
positioning an electrode adjacent an aperture in the frame;
charging the electrode with a second polarity opposite the first polarity;
attracting, with the electrode, the stream of particles toward the aperture in the frame;
separating, with the electrode, first particles having a predetermined quality from the stream of particles; and,
directing, with the electrode, the first particles through the aperture in the frame and into the collecting vessel.

41. The method recited in claim 40, further comprising:
electrically grounding the nozzle; and,
creating, using the electrode, an electrostatic field to:
attract the stream of particles toward the aperture;
separate the first particles from the stream of particles; and,
direct the first particles through the aperture and into the collecting vessel.

42. The method recited in claim 40, further comprising:
charging the nozzle with the first polarity; and,
creating, using the nozzle and the electrode, an electric field to:
attract the stream of particles toward the aperture;
separate the first particles from the stream of particles; and,
direct the first particles through the aperture and into the collecting vessel.

43. The method recited in claim 40, wherein the predetermined quality is a size of the particles.
